(19) United States
(12) Patent Application Publication
(10) Pub. No.: US 2010/0122782 A1
(43) Pub. Date: May 20, 2010

(54) Window Screen Assembly

(76) Inventors: Michael Fox, Janesville, WI (US); Carol Fox, Janesville, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/274,810

(22) Filed: Nov. 20, 2008

(51) Int. Cl. B60J 1/20; B60J 3/00

(52) U.S. Cl. 160/370.21; 296/97.9; 160/405

(57) ABSTRACT

The present invention is an improved window screen assembly for automotive vehicle windows comprised of a custom-fitted covering and at least one suction cup securing mechanism.

### FIELD OF INVENTION

This invention relates generally to the field of automotive vehicle window coverings, and specifically to an arcuate, self-supporting, custom-contoured window screen assembly for vehicle windows to provide privacy without interfering with the normal range of motion of functionality of a window assembly.

### BACKGROUND

According to the Bureau of Labor Statistics, there are an estimated 3.4 million truck drivers in the United States, 1.9 of who engage in extended and regular overnight trips in tractor-trailer trucks. These “over-the-road” truck drivers in particular must have accommodations for nights spent on the road. Typical tractor-trailer trucks are accommodated with sleeper compartments in or immediately adjacent to the cab of the truck, and provide a sleeping locations on is overnight trips. These sleeper compartments are not only used for rest, but for cooking, changing clothes, and relaxing after a drive.

In a sleeper, it is of high importance to maintain a level of privacy for the vehicle operator. Because sleepers are typically continuous with the cab of a truck, however, any windows in the truck, including the front windshield and especially door windows, allow a view into the cab and sleeper.

To provide privacy, the current practice in the art includes various types of curtains or screens which cover windows or isolate the entire sleeper compartment. Most of these curtains are suspended on a rod, shaft or track and hang from a door frame or other interior wall to block visibility from the windows.

However, the current practice has a number of problems. For instance, the placement and nature of curtains attached to a fixed interior vehicle wall blocks easy ingress and egress from the vehicle while the curtains are in use. Furthermore, the curtains that hang over front and side windows do not allow for the up or down operation of the windows while the curtains are in place, and frequently do not provide optimal privacy for a vehicle operator because curtains often have gaps. Additionally, vehicle windows traditionally provide little thermal protection, and privacy curtains add very little in cold weather. Trucks may have to use a separate heating source to maintain warmth through the night.

There have been attempts directed towards providing privacy to vehicle operators while avoiding the difficulty caused by using typical curtains known in the art, but none has solved the problems encountered by over-the-road truck drivers. U.S. Pat. No. 4,109,597 (Polizzi '957), for example, discloses a quickly removable windshield curtain for covering the front windshield and front passenger windows of a vehicle. The invention disclosed in Polizzi '957 is attached to the front windshield with suction cups and over the passenger windows with snaps. However, the design in Polizzi '957 does not solve the problem in the art of using the doors and windows while the device is in use, and cannot be formed to the specific dimensions of various vehicle windows.

There exists a need in the art to provide a device that provides privacy to a user inside a vehicle and also allows use of the doors and operations of the windows when a privacy cover is in place. It is desirable to have a window screen that is customized to conform to various window sizes and which maintains window and door functionality when in use.

Glossary

As used herein, the term “custom contoured” or “custom contoured” refers to a fitted component that can be placed on the interior window surface within a vehicle without altering or compromising the functionality of the window (e.g. rolling it up or down), and has structural which conforms to the shape, dimensions and contours of a window, in addition to simply covering it.

The term “marine grade vinyl” means a vinyl or equivalent material that is resistant to moisture, mildew, UV and temperature degradation, and is easily cut or deformed. As used herein, marine grade may any plastic, vinyl or fabric known in the art having these qualities.

As used herein, the term “secure attachment” means a suction cup, hinge, hook, snap, Velcro temporary or permanent adhesive, pressure sensitive device, rack, rod, or other mans known in the art for providing a secure attachment and custom fit of a window covering to a window. In various embodiments secure attachment members may include specially formulated silicon adhesive pads which temporarily adhere to cold, wet, hot, damp and glass surfaces, but are easily removed from the windshield, but are permanently affixed to the inner surface of a window covering.

As used herein, the term “color match” refers to a color tested in sunlight and coordinated with color formulations used for painting a vehicle. altering a material to different dimensions by any method know in the art, such as with scissors, a die, any sharp-edged metal, plastic or composite, or preformed variations thereof and which is adapted for the texture differences in the surfaces of a vehicle and the marine grade vinyl used herein to provide an aesthetically matched appearance of window screen assembly and its components as disclosed herein.

As used herein, the term “top edge” refers to any location within the upper four (4) inches of a covering, as used herein.

As used herein, the term “track opening” refers to the slot in a vehicle door into and out from which the vehicle's window vertically travels.

As used herein, the term “arcuate” means mathematically contoured to conform to the curvature of a window.

As used herein, the term “window track clearance measurement” which is a measurement that calculates the clearance necessary for the bottom edge of covering to the window track so that the functionality of a window when opening and closing the window is not affected.

As used herein, the term “window track clearance” means a space based on a window track clearance measurement.

A used herein, the term “spacer” means a component placed between a window track cover and a window surface to ensure window track clearance. A spacer may be a suction cup, pad, protuberance or any other structure know in the art to support a window covering at a desired distance from a window. In various embodiments, a secure attachment member may serve as a spacer.

### SUMMARY OF THE INVENTION

The present invention is an improved window screen assembly for trucking vehicle windows comprised of custom-fitted vinyl screen, color match vinyl and at least one suction cup securing mechanism. When in use, the window screen assembly allows functionality of both vehicle door and window.

### BRIEF DESCRIPTION OF THE DRAWINGS

FIG. 1A shows a front view of one embodiment of light and window screen assembly, and FIG. 1B shows the assembly in use in the interior (passenger) portion of a vehicle.

FIG. 2 shows a front view of one embodiment of front windshield component of a window screen assembly.

FIG. 3 shows a front view of one embodiment of a side windshield component of a window screen assembly.

FIG. 4 shows an exemplary embodiment using commercially available suction cups.

### DETAILED DESCRIPTION OF EMBODIMENTS OF THE INVENTION

For the purpose of promoting an understanding of the present invention, references are made in the text hereof to embodiments of a window screen assembly, only some of which are described herein. It should nevertheless be understood that no limitations on the scope of the invention are thereby intended. One of ordinary skill in the art will readily appreciate that modifications such as the dimensions of a window screen assembly, alternate but functionally similar material(s) from which the window screen assembly is made. The inclusion of additional elements may be deemed readily apparent and obvious to one of ordinary skill in the art, and all equivalent relationships to those described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near identical structural elements.

Moreover, the term “substantially” or “approximately” as used herein may be applied to modify any quantitative representation that could permissibly vary without resulting in a change in the basic function to which it is related. For example, one embodiment of the window screen assembly as disclosed herein may be comprised of a single multi-dimensional and/or textured component, while others may include multiple multi-dimensional and/or textured component.

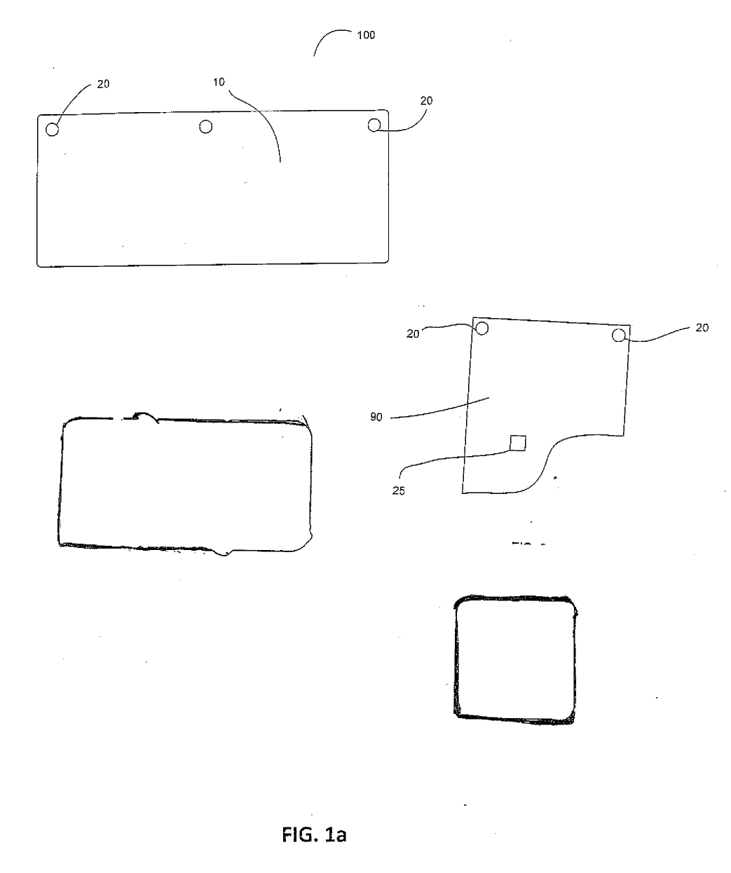

Referring now to the drawings, FIG. 1A shows a front view of one embodiment of window screen assembly 100 including a front windshield covering, side windshield covering and back windshield covering. In the embodiment shown, window screen assembly 100 is contoured to conform to the dimensions of tractor trailer truck models such as Kenworth T660 and T600, as well Freightliner Century or Columbia Class, but could alternatively be contoured to fit to any commercially available vehicle, taking into account the shape, dimensions, material, and contours and curvature of the vehicle windshield components.

FIG. 1B shows an exemplary window screen assembly in use in the interior passenger portion of a vehicle.

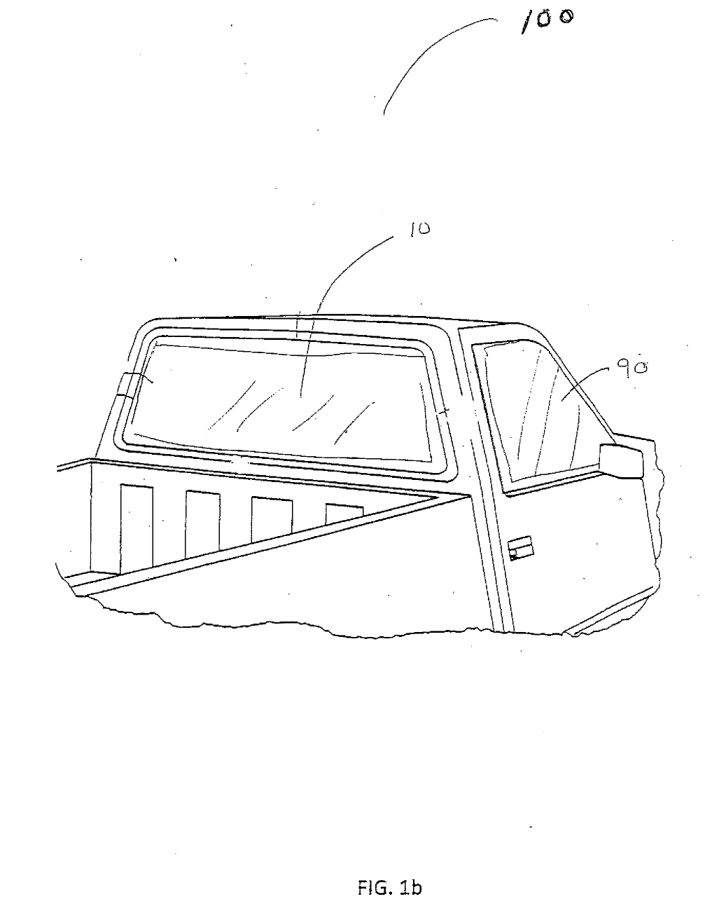

FIG. 2 illustrates an exemplary embodiment of front windshield covering 10, which in the embodiment shown is a front windshield covering.

Contoured front windshield covering 10 includes a plurality of securing mechanisms 20.

While front windshield covering 10 appears rectangular in shape, it is in fact slightly arcuate to compensate for the curvature of the window. In the embodiment shown, secure attachment members 20 are specially formulated silicon adhesive pads or other structures which are sufficiently thin to provide contact with the inner (window-side) surface of front windshield covering 10 to a windshield, for maximum heat retention, insulation, moisture resistance, cold resistance, privacy and a contoured appearance. In the embodiment shown, secure attachment members include an upper surface which temporarily adheres to cold, wet, hot, damp and glass surfaces, but are easily removed with bare fingers, a coin or laminated card. Other embodiments contemplate the use of commercially available suction cups, hooks, rod, adhesive and other pressure sensitive devices. In the embodiment shown front windshield covering may also be a side windshield covering, a back windshield covering.

In the embodiment shown in FIG. 2, secure attachment members 20 are temporarily attached to the outer surface of front windshield covering 10 and attached to the inner surface of a passenger window within the passenger compartment and outer surface covering color is a color match based on a system of matching the material for window covering 10 to vehicle upholstery colors and adjusting such colors for the light reflected through said window covering. In the embodiment shown in FIG. 2, secure attachment members 20 are two (2) inches from the top edge and two (2) inches from side edges of front windshield covering 10. In alternate embodiments, secure attachment members 20 can optionally be between one-quarter and two inches from the top edge or side edges.

To obtain the correct dimensions for a particular front windshield covering 10, dimensions are mathematically calculated using the dimensions and arc of a windshield component, the curvature of the windshield.

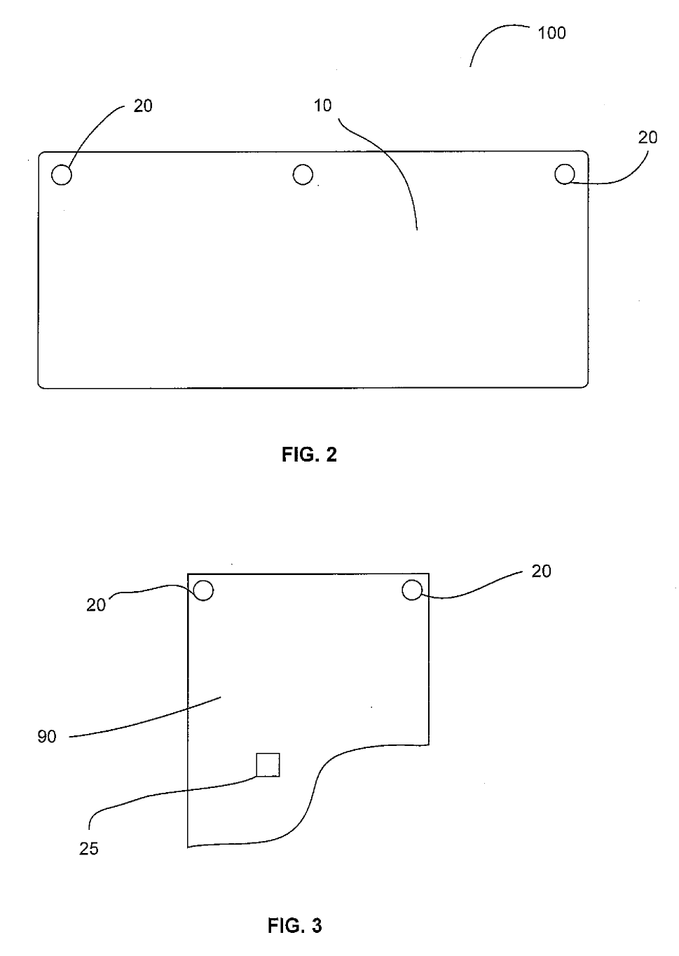

In the embodiment shown in FIG. 3, side windshield covering 90 is shown mathematically contoured, taking into account the curvature and shape of a side windshield. While the appearance of said side windshield covering 90 is shaped to fit substantially flush on a side windshield of a particular truck or other vehicle, it will be clear to one skilled in the art that covering 90 is contoured uniquely and shaped differently for the particular shape and manufacture of a particular side windshield. In the embodiment shown in FIG. 3, secure attachment members 20 are two (2) inches from the top edge and two (2) inches from side edges of side windshield covering 90. In alternate embodiments, secure attachment members 20 can optionally be between one-quarter and two inches from the top edge or side edges.

In the embodiment shown in FIG. 3, side windshield covering 90 is manufactured using a window track clearance measurement which is a measurement that calculates the clearance necessary for the bottom edge of covering to the window track so that the functionality of a window when opening and closing the window is not affected.

To manufacture custom-fitted window screen assembly components, e.g., windshield coverings 10 and 90 a template must be created which may be used (not shown). In various embodiments the template may be rigid form made of constructed of wood, plastic or other materials. In various other embodiments the template may be a cad design, software program, paper template, CNC tool specifications or a die cutting tool, die cutting pattern, punch press pattern, or punch press component.

In various embodiments, windshield covering 10 and 90 may be sized (smaller on any or all sides than a window in question to allow a desired amount of light or to minimize light inside the passenger area of the vehicle.

In various embodiments, windshield covering 10, 90 may contain multiple layers of marine grade vinyl or other fabric to enhance light obstruction, privacy or outward appearance. Multiple layers are connected by placing two one-sided vinyl fabric sheets against one another using flexible glue such as Roberts 2057 Thin-Set adhesive, or other similar glue that will not peel, dry or crack.

In further embodiments, covering 10 may be made with or from composite material that adheres to glass or coated with an adhesive and thus the inner surface of window coverings 10, 90 may serve secure attachment members 20. In various embodiments, and spacers 25 may be used for window track clearance where a window track is from 2.5 to 4 inches.

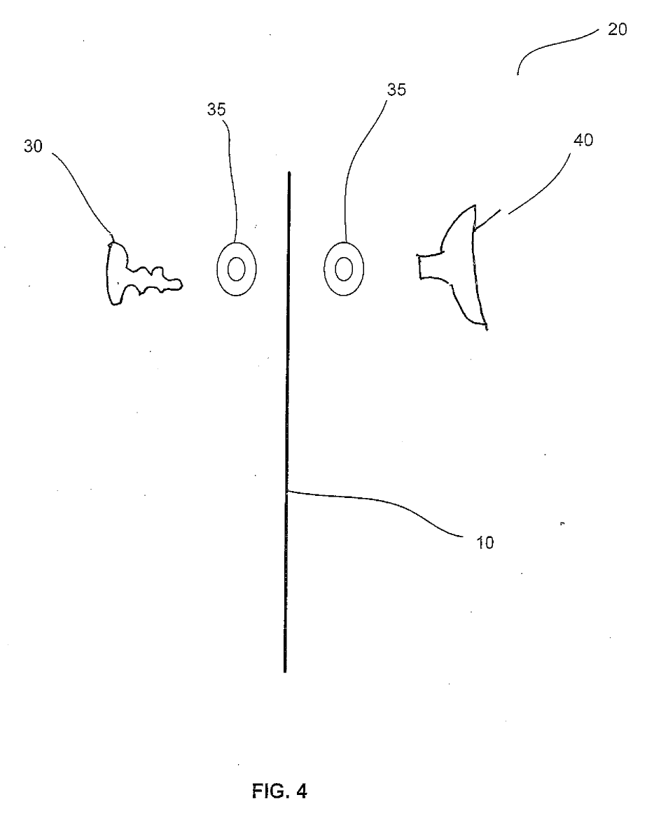

FIG. 4 shows an exploded side view of one embodiment of window covering 10 in which to which suction cups are use. These suction cups are commercially available, standard component, which may be repositioned within a plurality of apertures in the covering to accommodate them (e.g., shown in FIG. 3). As shown in the exemplary embodiment securing mechanism 20 is position along the top edge of covering 10, and is made up of screw fastener 30, which attaches to and through an opening in covering 10, buffered by washer 35, known in the art. Once attached through covering 10, screw fastener 35 screws into the hub of a conventional suction cup 40, through a second washer 35.

In the embodiment shown in FIG. 4, screw fastener 30 is a typical ⅜ inch screw, but in alternate embodiments, can be a screw of any size suitable to secure suction cup 40 to covering 10.

What is claimed is:

1. A custom-fitted window screen assembly comprised of:
at least one window covering component having an inner and an outer surface; and
at least one secure attachment member which is fixedly attached to the inner surface of said window covering and may be selectively attached to at least one window so as to substantially cover at least one window while leaving a window track clearance.

2. The custom-fitted window screen assembly of claim 1 wherein said at least one window covering is contoured to conform to the dimensions of at least one windshield by calculating the dimensions, material, window track clearance measurement and curvature of the vehicle windshield components.

3. The custom-fitted window screen assembly of claim 1 wherein said window track clearance is from 2.5 to 4 inches.

4. The custom-fitted window screen assembly of claim 1 wherein said window covering is made from at least two (2) layers of said covering which have said interior layers glued together.

5. The custom-fitted window screen assembly of claim 1 wherein said window covering is made from marine grade vinyl.

6. The custom-fitted window screen assembly of claim 1 wherein said window covering is made from a material selected from a group consisting of marine grade vinyl, denim, leather, woven wood or cloth.

7. The custom-fitted window screen assembly of claim 1 wherein said window covering further includes a spacer.

8. The custom-fitted window screen assembly of claim 1 wherein said window covering further includes at least one secure attachment member selected from a group consisting of means a suction cup, hinge, hook, snap, Velcro temporary or permanent adhesive, pressure sensitive device, rack a rod, a silicon adhesive and combination thereof.

9. The custom-fitted window screen assembly of claim 1 wherein said secure attachment member is a suction cup.

10. The custom-fitted window screen assembly of claim 1 wherein said at least one secure attachment member is an adhesive layer on the inner surface of said window covering.

11. The custom-fitted window screen assembly of claim 1 wherein said at least one secure attachment member is a silicon adhesive applied selectively and permanently to said inner surface of said window covering which may be selectively attached to a window surface.

12. A custom-fitted window screen system comprised of
a plurality of window covering components selected from a group consisting of grade vinyl, denim, leather, woven wood or cloth and combinations thereof, each of said window covering components having least one secure attachment member which is fixedly attached to the inner surface of said window covering and may be selectively attached to at one window so as to substantially cover at least one window while leaving a window track clearance for side windows, wherein said at least one window covering is contoured to conform to the dimensions of at least one windshield by calculating the dimensions, material, window track clearance measurement and curvature of the vehicle windshield components.

13. The custom-fitted window screen assembly of claim 12 wherein said window track clearance is from 2.5 to 4 inches.

14. The custom-fitted window screen assembly of claim 12 wherein said window covering is made from at least two (2) layers of said covering which have said interior layers glued together.

15. The custom-fitted window screen assembly of claim 12 wherein said window covering is made from marine grade vinyl.

16. The custom-fitted window screen assembly of claim 12 wherein said window covering is made from a material selected from a group consisting of grade vinyl, denim, leather, woven wood or cloth.

17. The custom-fitted window screen assembly of claim 12 wherein said window covering further includes a spacer.

18. The custom-fitted window screen assembly of claim 12 wherein said window covering further includes at least one secure attachment member selected from a group consisting of means a suction cup, hinge, hook, snap, Velcro, temporary or permanent adhesive, pressure sensitive device, rack, a rod, and a silicon adhesive applied selectively and permanently to said inner surface of said window covering.

19. A method of manufacturing a custom-fitted window screen assembly including the steps of:
Creating a template to cut at least one window covering by calculating the dimensions, material, window track clearance measurement and curvature of the vehicle windshield components;
Attaching at least one secure attachment component to at least one window covering.
